(19) United States
(12) Patent Application Publication
(10) Pub. No.: US 2025/0346202 A1
(43) Pub. Date: Nov. 13, 2025

(54) MOVABLE GUARD FOR VEHICLE FRONT END

(71) Applicant: Ford Global Technologies, LLC, Dearborn, MI (US)

(72) Inventors: Tony Barkachi, Gladstone Park/Victoria (AU); Seth Larris, Coburg/Victoria (AU); Benjamin James Wiley, Didsbury (GB); Christos George Konstadinopoulos, Lara/Victoria (AU)

(73) Assignee: Ford Global Technologies, LLC, Dearborn, MI (US)

(21) Appl. No.: 18/660,579

(22) Filed: May 10, 2024

(51) Int. Cl. B60R 19/40

(52) U.S. Cl. CPC B60R 19/40

(57) ABSTRACT

A vehicle includes a vehicle frame and a vehicle body supported by the vehicle frame. The vehicle body has a front end. The vehicle body defines a lateral axis and a longitudinal axis that is perpendicular to the lateral axis. The vehicle includes a guard supported by the vehicle frame and movable from a first position to a second position. The guard has a beam elongated along the lateral axis. The beam at the first position is below the beam at the second position. The beam at the second position is forward of and spaced from the front end of the vehicle body along the longitudinal axis. The guard in the second position extends downward from the beam to beneath the front end of the vehicle body.

### BACKGROUND

The Global Technology Regulation (GTR) and the New Car Assessment Program (NCAP) specify leg-injury criteria for pedestrian protection. The regulations are aimed at reducing the impact force to the legs of a pedestrian by a vehicle bumper during a vehicle-pedestrian impact.

Some vehicles, such as light duty trucks and sport utility vehicles (SUVs), for example, may have a relatively high bumper height that could lead to an uneven impact on the femur and/or tibia of the pedestrian by the vehicle bumper during the vehicle-pedestrian impact. For example, light duty trucks may have relatively high bumper heights to provide ground clearance to clear speed bumps, curbs, parking blocks, inclined driveway ramps, hills, rough roads, etc. Some vehicles that have relatively high bumper heights also have off-road capabilities that preclude having any components below the bumper. As such, there is an opportunity to design a vehicle front-end for pedestrian leg impact energy management while addressing ground clearance requirements.

### BRIEF DESCRIPTION OF THE DRAWINGS

FIG. 1 is a perspective view of a vehicle with a guard in a first position.

FIG. 2 is a perspective view of the vehicle with the guard in a second position.

FIG. 3 is a diagrammatic side view of a front portion of the vehicle with the guard at the first position and with an actuator for moving the guard.

FIG. 4 is a diagrammatic side view of the front portion of the vehicle with the guard at the second position and with the actuator for moving the guard.

FIG. 5 is a diagrammatic top view of the front portion of the vehicle with the guard at the first position.

FIG. 6 is a diagrammatic top view of the front portion of the vehicle with the guard at the second position.

FIG. 7 is a diagrammatic side view of the front portion of the vehicle with the guard at the first position and with a cable and a retractor for moving the guard.

FIG. 8 is a diagrammatic side view of the front portion of the vehicle with the guard at the second position and with the cable and the retractor for moving the guard.

FIG. 9 is a block diagram of components of the vehicle.

### DETAILED DESCRIPTION

A vehicle includes a vehicle frame and a vehicle body supported by the vehicle frame. The vehicle body has a front end. The vehicle body defines a lateral axis and a longitudinal axis that is perpendicular to the lateral axis. The vehicle includes a guard supported by the vehicle frame and movable from a first position to a second position. The guard has a beam elongated along the lateral axis. The beam at the first position is below the beam at the second position. The beam at the second position is forward of and spaced from the front end of the vehicle body along the longitudinal axis. The guard in the second position extends downward from the beam to beneath the front end of the vehicle body.

The guard may include a first support arm and a second support arm spaced from each other along the lateral axis, the first support arm and the second support arm connected to the beam and rotatable from the first position to the second position.

The first support arm and the second support arm may each include a first end rotably coupled to the vehicle frame and a second end fixed to the beam, and the first support arm and the second support arm may each include an arcuate portion curved toward the front end between the first end and the second.

The front end may include a bumper, and at the second position the first end may be spaced rearward from the bumper and the second end may be spaced forward of bumper along the longitudinal axis.

The vehicle frame may include a first frame rail and a second frame rail elongated along the longitudinal axis and spaced from each other along the lateral axis, the first support arm may be rotably coupled to the first frame rail and the second support arm may be rotably coupled to the second frame rail.

The vehicle body may include a front facia, and the beam at the second position may be forward of and spaced from the front facia along the longitudinal axis.

The front facia may include a class-A surface, and the beam at the second position may be forward of and spaced from the class-A surface along the longitudinal axis.

The front facia may include a bottom most edge, and the beam at the first position may be below the bottom most edge.

The beam at the second position may be above the bottom most edge of the front facia with the guard extending downward from the beam to beneath the bottom most edge of the front facia.

A forward or rearward distance of the beam at the first position from the front facia along the longitudinal axis may be predetermined based on a pedestrian leg form impactor test.

The beam at the first position may be within 6 inches forward or rearward of the front facia along the longitudinal axis.

The vehicle may include an actuator supported by the vehicle frame and operatively coupled to the guard to move the guard from the first position to the second position.

The actuator may include a cable and a retractor that retracts the cable to move the guard from the first position to the second position.

The vehicle may include a computer having a processor and a memory storing instructions executable by the processor to command the actuator to move the guard from the first position to the second position based on a location of the vehicle.

The instructions may include instructions to command the actuator to move the guard from the first position to the second position based on a comparison of the location of the vehicle with map data.

The map data may include roads, and the instructions may include instructions to command the actuator to move the guard from the first position to the second position based on a comparison of the location of the vehicle with the roads of the map data.

The vehicle may include a computer having a processor and a memory storing instructions executable by the processor to command the actuator to move the guard from the first position to the second position based on data from at least one of a camera or a lidar sensor.

The vehicle may include a computer having a processor and a memory storing instructions executable by the processor to command the actuator to move the guard from the first position the second position based on a speed of the vehicle.

The vehicle frame and the vehicle body may be of unitary construction.

The vehicle frame and the vehicle body may be of body-on-frame construction.

With reference to the Figures, wherein like numerals indicate like parts throughout the several views, a vehicle 10 is shown. The vehicle 10 includes a vehicle frame 12. The vehicle 10 includes a vehicle body 14 supported by the vehicle frame 12. The vehicle body 14 has a front end 16. The vehicle body 14 defines a lateral axis A1 and a longitudinal axis A2 that is perpendicular to the lateral axis A1. The vehicle 10 includes a guard 18 supported by the vehicle frame 12 and movable from a first position to a second position. The guard 18 has a beam 20 elongated along the lateral axis A1. The beam 20 at the first position is below the beam 20 at the second position. The beam 20 at the second position is forward of and spaced from the front end 16 of the vehicle body 14 along the longitudinal axis A2 with the guard 18 extending downward from the beam 20 to beneath the front end 16 of the vehicle body 14.

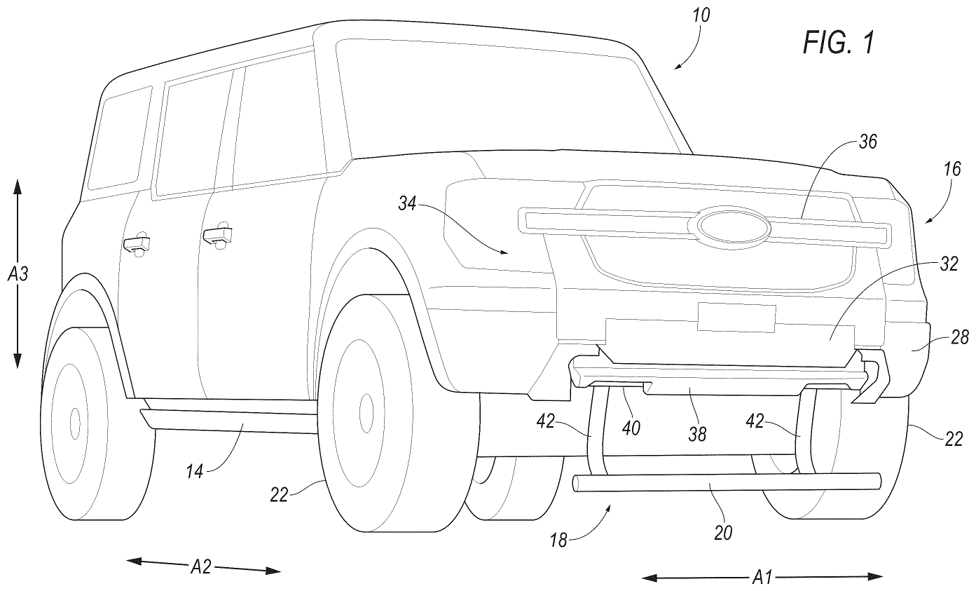

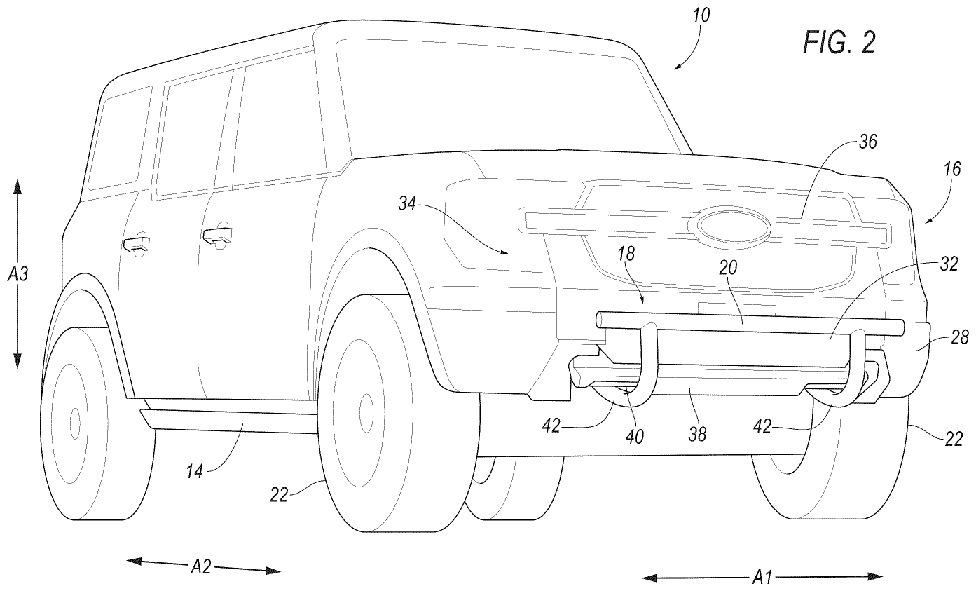

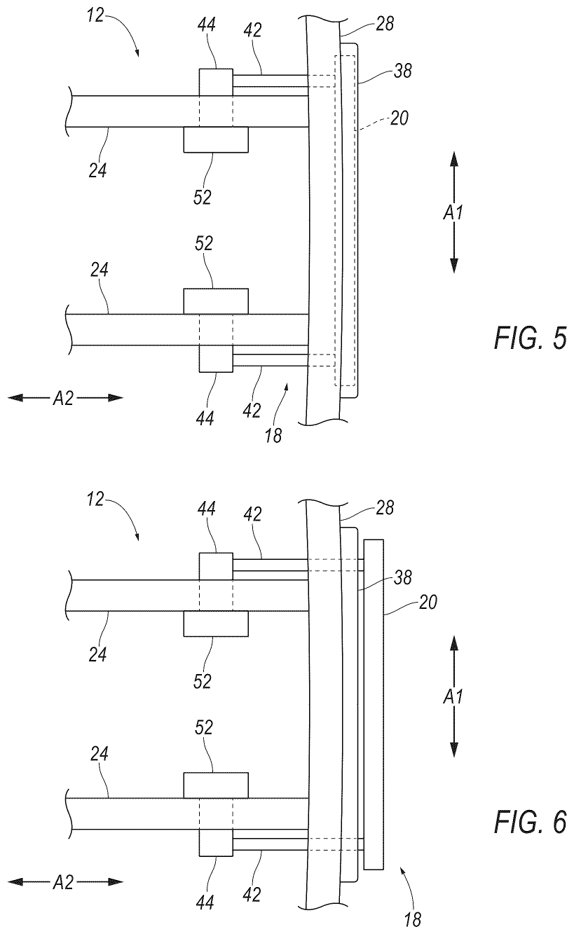

Movement of the guard 18 to the first position or the second position provides variable functionality to the guard 18. The guard 18 at the first position, shown in FIGS. 1, 3, 5, and 7, may control kinematics of a pedestrian, e.g., kinematics of a leg of the pedestrian coming into contact with the beam 20 at the first position. The guard 18 at the second position, shown in FIGS. 2, 4, 6, and 8, provides increased ground clearance and a steeper approach angle to the vehicle 10 at the front end 16, e.g., relative to the first position. The beam 20 at the second position may protect the front end 16 of the vehicle 10, e.g., from brush or other objects that may come in contact with the beam 20 when the vehicle 10 is traveling off-road.

With reference to FIGS. 1 and 2, the vehicle 10 may be any suitable type of automobile, e.g., a passenger or commercial automobile such as a sedan, a coupe, a truck, a sport utility vehicle, a crossover vehicle, a van, a minivan, a taxi, a bus, etc.

In the present description, relative vehicular orientations and directions (by way of example, top, bottom, front, rear, outboard, inboard, inward, outward, forward, rearward, lateral, left, right, etc.) are from the perspective of an occupant seated in the vehicle 10 and facing forward, e.g., toward a forward windshield of the vehicle 10. The forward direction of the vehicle 10 is the direction of movement of the vehicle 10 when the vehicle 10 is engaged in forward drive with wheels 22 of the vehicle 10 straight.

The vehicle body 14 defines a passenger cabin to house occupants, if any, of the vehicle 10. The passenger cabin may extend across the vehicle 10, i.e., from one side to the other side of the vehicle 10. One or more seats may be supported in the passenger cabin, e.g., by the floor of the vehicle body 14.

The vehicle body 14 defines the lateral axis A1 which extends between a left-side and a right-side of the vehicle body 14. The vehicle body 14 defines the longitudinal axis A2 which extends between a front and a rear of the vehicle body 14. The vehicle body 14 defines a vertical axis A3 which extends between a top and a bottom of the vehicle 10 boy. The lateral axis A1, the longitudinal axis A2, and the vertical axis A3 are perpendicular relative to each other.

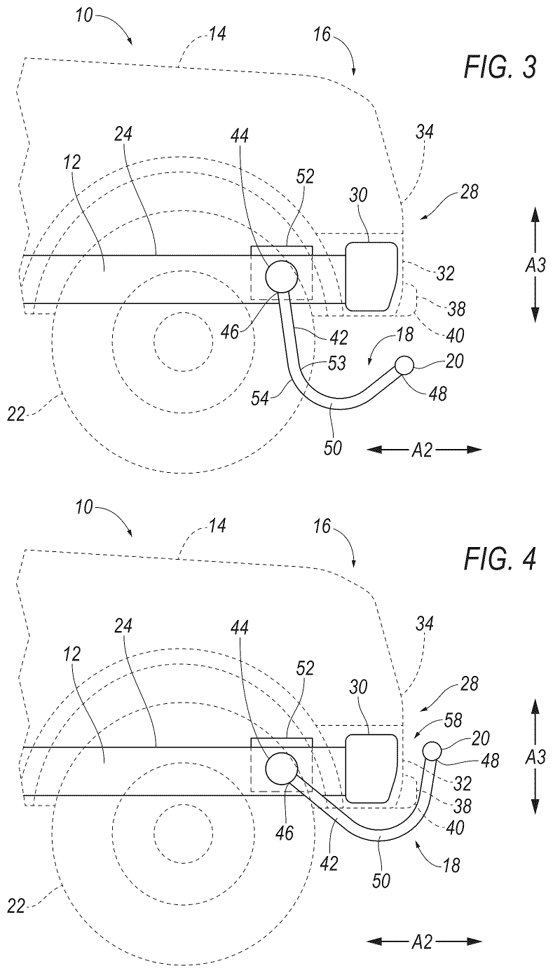

The vehicle frame 12, shown in FIGS. 3-8, supports the vehicle body 14. For example, the vehicle body 14 and the vehicle frame 12 may be of unitary construction (also referred to as unibody construction), in which the vehicle frame 12 is unitary with the vehicle body 14, e.g., including frame rails 24, rockers, pillars, roof rails, etc. As another example, the vehicle body 14 and frame may be a body-on-frame construction (also referred to as a cab-on-frame construction) in which the vehicle body 14 (including rockers, pillars, roof rails, etc.) and the vehicle frame 12 are separate components, i.e., are modular, and the vehicle body 14 is supported on and affixed to the vehicle frame 12, e.g., to the frame rails 24. Alternatively, the vehicle frame 12 and the vehicle body 14 may have any suitable construction. The vehicle frame 12 and the vehicle body 14 may be of any suitable material, for example, steel, aluminum, and/or fiber-reinforced plastic, etc.

The vehicle frame 12 may include a pair of frame rails 24, i.e., first and second frame rails 24. The frame rails 24 may be elongated along the longitudinal axis A2. In other words, the frame rails 24 may be longer along the longitudinal axis A2 than along the lateral axis A1 or the vertical axis A3. The frame rails 24 may be generally parallel to each other. The frame rails 24 may be spaced from each other along the lateral axis A1. For example, the first frame rail 24 may be closer to the right side of the vehicle 10 and the second frame rail 24 may be closer to the left side of the vehicle 10.

The frame rails 24 may extend from a rear end of the vehicle body 14 to the front end 16 of the vehicle body 14. In some examples, the first frame rail 24 and the second frame rail 24 may extend along substantially the entire length of the vehicle 10. In other examples, the first frame rail 24 and the second frame rail 24 may be segmented and extend under portions of the vehicle 10, e.g., at least extending from below the passenger compartment of the vehicle 10 to the front end 16. In some examples, the first frame rail 24 and the second frame rail 24 each may be unitary from the rear end to the front end 16. In other examples, the first frame rail 24 and the second frame rail 24, respectively, may each include segments fixed to each other (e.g., by welding, threaded fastener, etc.) and in combination extending from the rear end to the front end 16. The first frame rail 24 and the second frame rail 24 may include crush cans (not shown) at the front end 16 of the vehicle body 14. The crush cans may directly support a bumper 28 of the vehicle 10. In other words, the bumper 28 may abut the crush cans and the weight of the bumper 28 may be borne by the crush cans.

The front end 16 of the vehicle body 14 is a portion of the vehicle 10 that is forward of, for example, front wheels 22 of the vehicle 10 along the longitudinal axis A2. The front end 16 of the vehicle 10 includes the bumper 28 to distribute force and absorb energy, e.g., during certain impacts to the vehicle 10. Certain impacts to the vehicle 10 are impacts that are at or above a specified threshold amount of force and may also be dependent on location of the impact and/or angle of the impact. With reference to FIGS. 3-8, the bumper 28 may include a crossbeam 30, an energy absorber such as a crushable honeycomb structure and/or foam (not shown), an outer panel 32, and/or any other suitable structure. The bumper 28 is elongated along the lateral axis A1, e.g., extending from the right side of the vehicle 10 to the left side. The bumper 28 may be supported by, e.g., fixed to, the vehicle frame 12, e.g., via the crush cans. The bumper 28 may include components of the vehicle frame 12 and/or the vehicle body 14.

The crossbeam 30 of the bumper 28 is elongated along the lateral axis A1. The crossbeam 30 may be supported by the vehicle frame 12, i.e., the weight of the crossbeam 30 may be borne by the vehicle frame 12. The crossbeam 30 may be directly supported by the vehicle frame 12, specifically by the first frame rail 24 and the second frame rail 24, i.e., with no intermediate components between the crossbeam 30 and the first and second frame rails 24. For example, as shown in the example in the Figures, the crossbeam 30 may be supported directly by and fixed directly to the first frame rail 24 and the second frame rail 24. The crossbeam 30 may be any suitable material, for example, steel, aluminum, etc. The crossbeam 30 may be fixed to the first frame rail 24 and the second frame rail 24, e.g., via fastener, weld, etc.

The bumper 28 may include the outer panel 32 to provide an aesthetic appearance to the bumper 28. The outer panel 32 may be elongated generally parallel to the crossbeam 30. The outer panel 32 may extend around the crossbeam 30. The outer panel 32 may present a class-A surface, i.e., a finished surface exposed to view by a customer and specifically manufactured to have a high-quality, finished aesthetic appearance free of unaesthetic blemishes and defects. The outer panel 32 may be supported by the vehicle frame 12, the vehicle body 14, and/or the crossbeam 30. The outer panel 32 may be a component of the vehicle body 14.

The front end 16 of the vehicle body 14 includes a front facia 34. The front facia 34 includes forward facing components of the front end 16 and provides an aesthetic appearance to a forwardmost portion of the front end 16. The front facia 34 may include, for example, a grille 36, headlamps, the outer panel 32 of the bumper 28, forward facing body panels of the vehicle body 14, a bumper valance 38 attached to a bottom of the bumper 28, etc. The front facia 34, i.e., the components of the front end 16 that provide the front facia 34, include class-A surfaces. For example, the outer panel 32 of the bumper 28, the grille 36, the headlamps, the forward facing body panels of the vehicle body 14, the bumper valance 38, etc., may each have a class-A surface. The grille 36 is disposed above the bumper 28. The grille 36 may include one or more openings, e.g., permitting airflow to a radiator, air intake, or other structure of the vehicle 10. The bumper valance 38 may be fixed at the bottom of the bumper 28, e.g., to provide a certain aesthetic to the vehicle 10 and block a view of an undercarriage of the vehicle 10. The bumper valance 38 may be plastic or any suitable material.

The front facia 34 includes a bottom most edge 40. The bottom most edge 40 is an edge of one or more components of the front facia 34 that are closest to a ground supporting the vehicle 10. In other words, the bottom most edge 40 of the front facia 34 is closer to ground than the remainder of the front facia 34. The bottom most edge 40 is elongated along the lateral axis A1. The bottom most edge 40 may extend along, e.g., the bumper valance 38. The bottom most edge 40 may vary in height. In other words, certain portions of the bottom most edge 40 may be closer to the ground than other portions of the bottom most edge 40.

The guard 18 may control kinematics of a pedestrian that comes in contact with the front end 16 of the vehicle 10 or may reduce or eliminate impact with the front end 16, e.g., depending on whether the guard 18 is at the first position or at the second position. The guard 18 is movable from the first position to the second position and vice versa, e.g., as described below.

The guard 18 at the first position is shown in FIGS. 1, 3, 5, and 7 and may control kinematics of a pedestrian that comes in contact with the front end 16 of the vehicle 10. For example, the guard 18 may provide additional support to a leg of the pedestrian below the bottom most edge 40 of the front facia 34. The guard 18 at the second position is shown in FIGS. 2, 4, 6, and 8 and may reduce or eliminate impact with the front end 16, e.g., by preventing an object from coming into contact with one or more components of the front facia 34. For example, the guard 18 at the second position may block objects forward of the vehicle 10 from coming into contact with the outer panel 32 of the bumper 28, the grille 36, the bumper valance 38, etc.

The guard 18 includes the beam 20 to control kinematics of a pedestrian and to reduce or eliminate impact with the front end 16. The beam 20 is elongated along the lateral axis A1. In other words, the beam 20 is longer along the lateral axis A1 than along the longitudinal axis A2 or the vertical axis A3. The beam 20 may extend from the right side of the vehicle 10 to the left side of the vehicle 10, e.g., forward of and between front wheels 22 of the vehicle 10. The beam 20 may be rectangular, circular, or any suitable shape in cross section. The beam 20 may be metal, plastic, carbon fiber, or any suitable material that provides sufficient stiffness to control kinematics of a pedestrian and to may reduce or eliminate impact with the front end 16.

The guard 18 is supported by the vehicle frame 12. In other words, weight of the guard 18 is borne by the vehicle frame 12. For example, the guard 18 may include one or more support arms 42, e.g., first and second support arms 42 for supporting the beam 20 relative to the vehicle body 14. The first and second support arms 42 may be spaced from each other along the lateral axis A1. For example, one of the support arms 42 may be closer to the right side of the vehicle 10 and the other of the support arms 42 may be closer to the left side of the vehicle 10.

The support arms 42 are rotatable relative to the vehicle body 14 from the first position to the second position. For example, a hinge pin 44, bushing, bearing, and/or other suitable structure that allows rotation of the support arm 42 relative to the vehicle frame 12 and inhibits translational movement of the support arm 42 relative to the vehicle frame 12 may rotably couple the support arm 42 to the vehicle frame 12. The first support arm 42 may be rotably coupled to the first frame rail 24, The second support arm 42 may be rotably coupled to the second frame rail 24. For example, the hinge pin 44 of the first support arm 42 may be disposed within a hole of the first frame rail 24 and the hinge pin 44 of the second support arm 42 may be disposed within a hole of the second frame rail 24.

The support arms 42 are connected to the beam 20. For example, the support arms 42 may be fixed to the beam 20 via weld, fastener, or other suitable structure. As another example, the beam 20 and the support arms 42 may be monolithic. Monolithic means a single, uniform piece of material with no seams, joints, fasteners, or adhesives holding it together, i.e., formed together simultaneously as a single continuous unit, e.g., by machining from a unitary blank, molding, extruding, 3-D printing, etc. Non-monolithic components, in contrast, are formed separately and subsequently assembled, e.g., by threaded engagement, welding, etc. The support arms 42 may be metal, plastic, carbon fiber, or any suitable material that provides sufficient stiffness to control kinematics of a pedestrian and to reduce or eliminate impact with front end 16.

With reference to FIGS. 3, 4, 7, and 8, the first support arm 42 and the second support arm 42 may each include a first end 46 and a second end 48 spaced from the first end 46. The first end 46 and the second end 48 may each be at distal ends of the support arms 42. The first ends 46 of the support arms 42 may be rotably coupled to the vehicle frame 12, e.g., the hinge pins 44 or other suitable structure that allows rotation of the support arms 42 relative to the vehicle frame 12 may be at the first ends 46. The hinge pin 44 may rotate concurrently with the first end 46. For example, the hinge pin 44 may be fixed to the support arm 42 at the first end 46, e.g., via weld, fastener, etc. As another example, the hinge pin 44 may be coupled to the first end 46 with a spline or other suitable structure for transferring torque. The second ends 48 of the support arms 42 may be fixed to the beam 20, e.g., via weld, fastener, or other suitable structure. The second ends 48 of the support arms 42 and the beam 20 may be monolithic.

The first support arm 42 and the second support arm 42 may each include an arcuate portion 50 between the first end 46 and the second end 48. The arcuate portion 50 enables the support arms 42 to extend below bottom most edge 40 of the front facia 34, e.g., at the second position and with the first end 46 and the second ends 48 above the bottom most edge 40. The arcuate portion 50 is curved. For example, the arcuate portion 50 may define a single curve that extends from the first end 46 to the second end 48. The arcuate portion 50 may include additional curves, corners, or other structures. The arcuate portion 50 may be curved toward the front end 16 of the vehicle body 14. In other words, an inner side 53 of the curve of the arcuate portion 50 may be forward of an outer side 54 of the curve of the arcuate portion 50, e.g., at the first position.

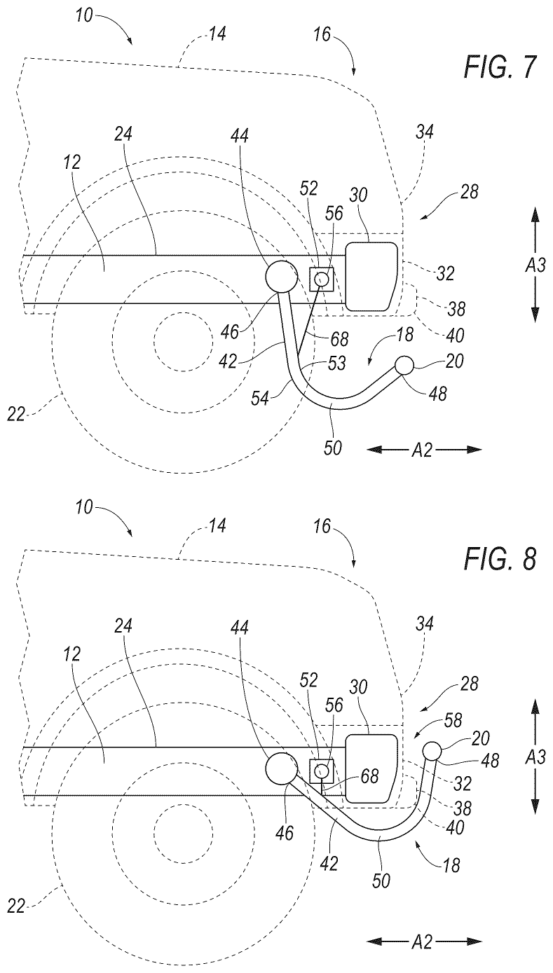

With reference to FIGS. 1, 3, 5, and 7, the guard 18 at the first position is shown. The guard 18 at the first position may support a leg of a pedestrian that comes into contact with the front end 16 of the vehicle 10. For example, the outer panel 32 of the bumper 28 may come in contact with the leg above a knee of the pedestrian and the beam 20 may contact the leg below the knee. The beam 20 at the first position is below the beam 20 at the second position along the vertical axis A3. Compare, for example, FIGS. 3 and 7 showing the beam 20 at the first position with FIGS. 4 and 8 showing the beam 20 at the second position. The beam 20 at the first position is below the bottom most edge 40 of the front facia 34 along the vertical axis A3. For example, the beam 20 at the first position may be generally midway between the bottom most edge 40 and the ground supporting the vehicle 10. The beam 20 at the first position may be generally aligned with the front facia 34 along the longitudinal axis A2. For example, the beam 20 at the first position may be within 6 inches forward or rearward of the front facia 34 along the longitudinal axis A2. The forward or rearward distance from the front facia 34 may be from a front most surface of the front facia 34, e.g., a front surface of the outer panel 32 of the bumper 28.

The forward or rearward distance of the beam 20 at the first position from the front facia 34 along the longitudinal axis A2 may be predetermined based on a pedestrian leg form impactor test. Similarly, the vertical distance of the beam 20 at the first position from the front facia 34, e.g., from the bottom most edge 40, may be predetermined based on a pedestrian leg form impactor test. A pedestrian leg form impactor test is a test that uses a crash testing tool representing a human leg (i.e., a leg form), typically a 50th percentile male leg, which simulates the flexible nature of human leg bones. The pedestrian leg form impactor test measures a result of controlled impact between, e.g., the vehicle 10 and the leg form. The pedestrian leg form impactor test may provide an assessment of knee, upper, and/or lower leg kinematics. The predetermined forward or rearward distance of the beam 20 and/or the vertical distance of the beam 20 may be determined based on the results of one or more of pedestrian leg form impactor tests. For example, one or more pedestrian leg form impactor tests may indicate which distances provided certain knee, upper, and/or lower leg kinematics.

With reference to FIGS. 2, 4, 6, and 8, the guard 18 at the second position is shown. The guard 18 at the second position may protect the front end 16, e.g., by blocking an object in front of the vehicle 10 from coming into contact with the front facia 34. The beam 20 at the second position is forward of vehicle body 14, e.g., forward of the front facia 34 along the longitudinal axis A2. The beam 20 at the second position is spaced from the front end 16 of the vehicle body 14, e.g., spaced from the front facia 34. Spacing the beam 20 from the front end 16 of the vehicle 10 provides a gap 58, e.g., between the beam 20 and the front facia 34. The gap 58 enables a certain amount of rearward flex of the beam 20 without contact between the beam 20 and the front facia 34, e.g., as a result of an object coming into contact to the beam 20. The beam 20 at the second position may be forward of and spaced from the class-A surface of the front facia 34 along the longitudinal axis A2, e.g., protecting the aesthetic appearance of the class-A surface. The beam 20 at the second position is above the bottom most edge 40 of the front facia 34 along the vertical axis A3.

The guard 18 at the second position extends downward from the beam 20 to beneath, i.e., directly below, the front end 16 of the vehicle body 14. The guard 18 may extend beneath the bottom most edge 40 of the front facia 34. For example, the support arms 42 may extend downward from the beam 20 to below the front facia 34 along the vertical axis A3 and rearward along the lateral axis A1 to beneath the bottom most edge 40 of the front facia 34. The support arms 42 at the second position may be spaced from front facia 34, including from the bottom most edge 40. Spacing the support arms 42 from the front facia 34 inhibits the front facia 34 from interfering with movement of the support arms 42.

At the second position the first ends 46 of the support arms 42 are spaced rearward from the bumper 28 and the second ends 48 of the support arms 42 are spaced forward of bumper 28 along the longitudinal axis A2. In other words, the support arms 42 at the second position extend from rearward of the bumper 28 to forward of the bumper 28, e.g., with the arcuate portions 50 of the support arms 42 beneath the bumper 28.

With reference to FIGS. 3-9, the vehicle 10 may include one or more actuators 52 for moving the guard 18 from the first position to the second position, and vice versa. The actuators 52 may include a motor, a servo, a hydraulic or pneumatic piston and cylinder arrangement, a spring, a solenoid, and/or any suitable structure for effectuating movement. The actuators 52 may be rotary, i.e., generating rotational movement or torque, or linear, i.e., generating translational movement or linear force. The actuators 52 may be supported by the vehicle frame 12. In other words, the weight of the actuators 52 may be borne be the vehicle frame 12. For example, one actuator 52 may be fixed to the first frame rail 24 and another actuator 52 may be fixed to the second frame rail 24. The actuators 52 may be fixed to the frame rails 24 via fasters or any suitable structure. The actuators 52 may be operatively coupled to the guard 18 to move the guard 18 from the first position to the second position. For example, and with reference to FIGS. 3 and 4, the actuators 52 may each include a motor and reduction gears (not shown) that transfer torque from the motor to the hinge pin 44. As another example, and with reference to FIGS. 7 and 8, the actuator 52 may include a cable 68 and a retractor 56 that retracts the cable 68 to move the guard 18 from the first position to the second position. The retractor 56 may include an electric motor that rotates a spool to wind (i.e., retract) or unwind the cable 68 from the spool. The cable 68 may be fixed, e.g., to the support arm 42. Winding, i.e. retraction, of the cable 68 by the retractor 56 may move the guard 18 toward the second position. Unwinding of the cable 68 may move the guard 18 toward the first position.

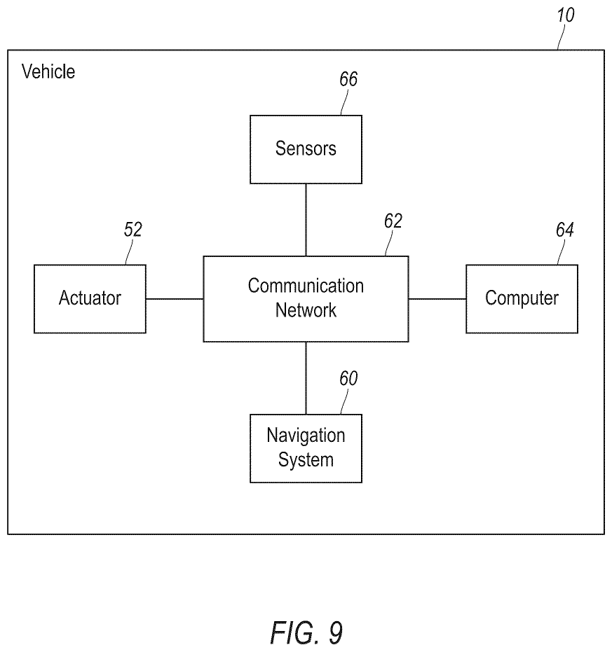

With reference to FIG. 9, the vehicle 10 can include a variety of sensors 66. Some sensors 66 detect internal states of the vehicle 10, for example, wheel speed, wheel orientation, suspension actuation, ride height, and engine and transmission values. Some sensors 66 detect the position or orientation of the vehicle 10, for example, global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. Some sensors 66 detect the external world, for example, radar sensors, scanning laser range finders, light detection and ranging (LIDAR) devices, and image processing sensors such as cameras. A LIDAR device detects distances to objects by emitting laser pulses and measuring the time of flight for the pulse to travel to the object and back.

The vehicle 10 may include a navigation system 60. The navigation system 60 is implemented via circuits, chips, or other electronic components that can determine a present location of the vehicle 10. The navigation system 60 may be implemented via a satellite-based system such as the Global Positioning System (GPS). The navigation system 60 may triangulate the location of the vehicle 10 based on signals received from various satellites in the Earth's orbit. The navigation system 60 is programmed to output signals representing the present location of the vehicle 10 to, e.g., the computer 64 via a vehicle communication network 62. In some instances, the navigation system 60 is programmed to determine a route from the present location of the vehicle 10 to a future location. The navigation system 60 may access map data specifying a map of a certain geographic area, e.g., stored in memory of the computer 64, and develop the route according to the map data. The map data includes roads. For example, the map data may include data indicating the locations of road in the map specified by the map data. The map may include data specifying lanes of roads of the map, e.g., including turn lanes, a direction of traffic flow for the lanes, a speed limit, etc.

The communication network 62 includes hardware, such as a communication bus, for facilitating communication among components of the vehicle 10, e.g., the actuator 52, the sensors 66, the navigation system 60, a computer 64, etc. The communication network 62 may facilitate wired or wireless communication among the components in accordance with a number of communication protocols such as controller area network (CAN), Ethernet, WiFi, Local Interconnect Network (LIN), and/or other wired or wireless mechanisms. Alternatively or additionally, in cases where the computer 64 comprises a plurality of devices, the communication network 62 may be used for communications between devices represented as the computer 64 in this disclosure.

The computer 64 includes a processor, a memory, etc. The memory of the computer 64 may include memory for storing programming instructions executable by the processor as well as for electronically storing data and/or databases. The computer 64 may be a microprocessor-based computer implemented via circuits, chips, or other electronic components. For example, the computer 64 can be a generic computer with a processor and memory as described above and/or may include an electronic control unit (ECU) or controller for a specific function or set of functions, and/or a dedicated electronic circuit including an ASIC that is manufactured for a particular operation, e.g., an ASIC for processing sensor data and/or communicating the sensor data. In another example, computer 64 may include an FPGA (Field-Programmable Gate Array) which is an integrated circuit manufactured to be configurable by a user. Typically, a hardware description language such as VHDL (Very High-Speed Integrated Circuit Hardware Description Language) is used in electronic design automation to describe digital and mixed-signal systems such as FPGA and ASIC. For example, an ASIC is manufactured on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in the computer 64. The memory can be of any type, e.g., hard disk drives, solid state drives, servers, or any volatile or non-volatile media. The memory can store the collected data sent from the sensors 66.

The computer 64 is programmed to, i.e., the memory stores instructions executable by the processor to, command the actuator 52 to move the guard 18 from the first position to the second position, and vice versa. The computer 64 may command the actuator 52 to move the guard 18 by transmitting a command to the actuator 52 via the communication network 62. For example, the command may instruct the motor of the actuator 52 to rotate in one direction or another, or the command may instruct the actuator 52 to increase or decrease in length. The command may instruct a specified number of rotations or change to a certain length. The command may instruct continued rotation and/or length change until the guard 18 is at a certain position, e.g., as detected by one or more sensors 66 that provide feed to the computer 64.

The instructions may include instructions to command the actuator 52 to move the guard 18 from the first position to the second position based on a location of the vehicle 10. The computer 64 may determine the location of the vehicle 10 based on data from the sensors 66 and/or the navigation system 60. The location of the vehicle 10 may be a GPS location, a location relative to map data, or a location relative to some of suitable datum or coordinate system. The computer 64 may determine whether or not the location of the vehicle 10 is on a road, i.e., a smooth surface prepared to facilitate traffic, such as a paved road, a gravel road, a highway or expressway, etc. In response to determining the location indicates the vehicle 10 is on a road, the computer 64 may maintain the guard 18 at the first position. In response to determining the location indicates the vehicle 10 is not on a road, i.e., the vehicle 10 is “off-road” the computer 64 may move the guard 18 to the second position. For example, the computer 64 may command the actuator 52 to move the guard 18 from the first position to the second position based on a comparison of the location of the vehicle 10 with map data. The computer 64 may compare the detected location of the vehicle 10 with the roads of the map data. In response to determining the location of the vehicle 10 is not on or within a threshold distance of one of the roads of the map data the computer 64 may move the guard 18 from the first position to the second portion. In response to determining the location of the vehicle 10 is on or within a threshold distance of one of the roads of the map data the computer 64 may move the guard 18 from the second position to the first portion.

The instructions may include instructions to command the actuator 52 to move the guard 18 from the first position to the second position based on data from at least one of a camera or a lidar sensor. The computer 64 may analyze the data from at least one of a camera or a lidar sensor, e.g., using image recognition, machine learning, or other suitable technique, to determine when the vehicle 10 is on-road and/or when additional ground clearance would be beneficial to operation of the vehicle 10. In response to determining the vehicle 10 is on-road and/or additional ground clearance would not be beneficial to operation of the vehicle 10, the computer 64 may maintain the guard 18 at the first position. In response to determining the vehicle 10 is not on-road and/or additional ground clearance would be beneficial to operation of the vehicle 10, the computer 64 may move the guard 18 to the second position.

The instructions may include instructions to command the actuator 52 to move the guard 18 from the from the first position the second position based on a speed of the vehicle 10. The computer 64 may detect the speed of the vehicle 10 based on data from one or more of the sensors 66. For example, the computer 64 may compare the detected speed to a threshold, e.g., 25 mph. In response to determining the detected speed of the vehicle 10 is below the threshold, the computer 64 may maintain the guard 18 at the first position. In response to determining the detected speed of the vehicle 10 is above the threshold, the computer 64 may move the guard 18 to the second position.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The numerical adjectives “first,” “second,” etc., are used herein merely as identifiers and do not signify order or importance. Use of “in response to,” “based on,” and “upon” herein indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A vehicle, comprising:
a vehicle frame;
a vehicle body supported by the vehicle frame, the vehicle body having a front end, the vehicle body defining a lateral axis and a longitudinal axis that is perpendicular to the lateral axis; and
a guard supported by the vehicle frame and movable from a first position to a second position, the guard having a beam elongated along the lateral axis, the beam at the first position is below the beam at the second position, and the beam at the second position is forward of and spaced from the front end of the vehicle body along the longitudinal axis, the guard in the second position extending downward from the beam to beneath the front end of the vehicle body.

2. The vehicle of claim 1, wherein the guard includes a first support arm and a second support arm spaced from each other along the lateral axis, the first support arm and the second support arm connected to the beam and rotatable from the first position to the second position.

3. The vehicle of claim 2, wherein the first support arm and the second support arm each include a first end rotably coupled to the vehicle frame and a second end fixed to the beam, and wherein the first support arm and the second support arm each include an arcuate portion curved toward the front end between the first end and the second.

4. The vehicle of claim 3, wherein the front end includes a bumper, and wherein at the second position the first end is spaced rearward from the bumper and the second end is spaced forward of bumper along the longitudinal axis.

5. The vehicle of claim 2, wherein the vehicle frame includes a first frame rail and a second frame rail elongated along the longitudinal axis and spaced from each other along the lateral axis, wherein the first support arm is rotably coupled to the first frame rail and the second support arm is rotably coupled to the second frame rail.

6. The vehicle of claim 1, wherein the vehicle body includes a front facia, and wherein the beam at the second position is forward of and spaced from the front facia along the longitudinal axis.

7. The vehicle of claim 6, wherein the front facia includes a class-A surface, and wherein the beam at the second position is forward of and spaced from the class-A surface along the longitudinal axis.

8. The vehicle of claim 7, wherein the front facia includes a bottom most edge, and wherein the beam at the first position is below the bottom most edge.

9. The vehicle of claim 8, wherein the beam at the second position is above the bottom most edge of the front facia with the guard extending downward from the beam to beneath the bottom most edge of the front facia.

10. The vehicle of claim 6, wherein a forward or rearward distance of the beam at the first position from the front facia along the longitudinal axis is predetermined based on a pedestrian leg form impactor test.

11. The vehicle of claim 6, wherein the beam at the first position is within 6 inches forward or rearward of the front facia along the longitudinal axis.

12. The vehicle of claim 1, further comprising an actuator supported by the vehicle frame and operatively coupled to the guard to move the guard from the first position to the second position.

13. The vehicle of claim 12, wherein the actuator includes a cable and a retractor that retracts the cable to move the guard from the first position to the second position.

14. The vehicle of claim 12, further comprising a computer having a processor and a memory storing instructions executable by the processor to command the actuator to move the guard from the first position to the second position based on a location of the vehicle.

15. The vehicle of claim 14, wherein the instructions include instructions to command the actuator to move the guard from the first position to the second position based on a comparison of the location of the vehicle with map data.

16. The vehicle of claim 15, wherein the map data include roads, and wherein the instructions include instructions to command the actuator to move the guard from the first position to the second position based on a comparison of the location of the vehicle with the roads of the map data.

17. The vehicle of claim 12, further comprising a computer having a processor and a memory storing instructions executable by the processor to command the actuator to move the guard from the first position to the second position based on data from at least one of a camera or a lidar sensor.

18. The vehicle of claim 12, further comprising a computer having a processor and a memory storing instructions executable by the processor to command the actuator to move the guard from the first position the second position based on a speed of the vehicle.

19. The vehicle of claim 1, wherein the vehicle frame and the vehicle body are of unitary construction.

20. The vehicle of claim 1, wherein the vehicle frame and the vehicle body are of body-on-frame construction.
